(19) United States
(12) Patent Application Publication
(10) Pub. No.: US 2017/0262507 A1
(43) Pub. Date: Sep. 14, 2017

(54) FEEDBACK MECHANISM FOR QUERY EXECUTION

(71) Applicant: INTERNATIONAL BUSINESS MACHINES CORPORATION, ARMONK, NY (US)

(72) Inventors: Charan Acharya Chandrashekar, Siddapur (IN); Dattatreya Govindappanavar, Hirekerur (IN); Apoorv Kapse, Bangalore (IN); Gaurav Saxena, Bangalore (IN)

(21) Appl. No.: 15/066,150

(22) Filed: Mar. 10, 2016

(51) Int. Cl. G06F 17/30; G06Q 30/02

(52) U.S. Cl. CPC G06F 17/30522; G06F 17/30477; G06F 17/3056; G06Q 30/0283

(57) ABSTRACT

A method and system for generating feedback for query execution is presented. The method and system includes receiving an instruction, using a computer, to perform a query from a user; performing the query instruction by accessing the database on a network; and determining a network traffic of the network in response to the query instruction performance timing out. The method and system also includes calculating a time and cost needed to complete the query instruction, in response to the query instruction performance timing out and presenting the calculated data to a user with an option to complete the timed out query. The method and system includes requesting and receiving a grace time to complete the query from the user in response to the user accepting the option to complete the query. The query is performed based on the grace time.

### BACKGROUND

The present disclosure relates generally to the field of computer systems and more particularly to a feedback mechanism for optimizing query execution.

Generally, a query is a request for information from a database. A database is a collection of information that is organized so that it can easily be accessed, managed, and updated. In one view, databases can be classified according to types of content: bibliographic, full-text, numeric, and images. Typically, there are three general methods for posing queries: Choosing parameters from a menu: In this method, the database system presents a list of parameters from which a user may choose; Query by example (QBE): In this method, the system presents a blank record and allows a user to specify the fields and values that define the query; and Query language: Many database systems require the user to make requests for information in the form of a stylized query that must be written in a special query language. In other words, query language is a computer programming language used to retrieve information from a database. The uses of query language and databases are manifold. They provide a means of retrieving records or parts of records and performing various calculations before displaying the results.

As time and size of databases have grown exponentially, when a new query is initiated in a busy database or big data system, the resources to execute the query like CPU, IO etc. allocation has become paramount. Many busy users have utilized a query optimizer in order to ease this allocation. Even though generally an optimizer provides a plan to perform and manage multiple queries, many times the query is unsatisfactory to the end user. The user may not want to execute a query, if the result is delayed more than a certain amount of time.

### SUMMARY

The present disclosure implements a system, a computer-implemented method, and computer program product for generating feedback for query execution. In an embodiment, the method includes receiving an instruction, using a computer, to perform a query from a user, the query including a request for information from a database communicating with the computer. The method includes performing the query instruction by accessing the database on a network. The method includes determining a network traffic of the network in response to the query instruction performance timing out. The method includes calculating a time needed to complete the query instruction, using a query graph model and the network traffic, in response to the query instruction performance timing out. The method includes calculating a cost of the query performance using a query instruction graph model, in response to the query instruction performance timing out. The method includes presenting the calculated cost of query and the time needed to perform the query instruction to the user. The method includes presenting the user with an option to complete the query.

In another embodiment a computer program product for generating feedback for query execution is provided the computer program product includes receiving an instruction, using a computer, to perform a query from a user, the query including a request for information from a database communicating with the computer. The computer program product includes performing the query instruction by accessing the database on a network. The computer program product includes determining a network traffic of the network in response to the query instruction performance timing out. The computer program product includes calculating a time needed to complete the query instruction, using a query graph model and the network traffic, in response to the query instruction performance timing out. The computer program product includes calculating a cost of the query performance using a query instruction graph model, in response to the query instruction performance timing out. The computer program product includes presenting the calculated cost of query and the time needed to perform the query instruction to the user.

In another embodiment a computer system for generating feedback for query execution is provided the computer system includes receiving an instruction, using a computer, to perform a query from a user, the query including a request for information from a database communicating with the computer. The computer system includes performing the query instruction by accessing the database on a network. The computer system includes determining a network traffic of the network in response to the query instruction performance timing out. The computer system includes calculating a time needed to complete the query instruction, using a query graph model and the network traffic, in response to the query instruction performance timing out. The computer system includes calculating a cost of the query performance using a query instruction graph model, in response to the query instruction performance timing out. The computer system includes presenting the calculated cost of query and the time needed to perform the query instruction to the user.

### BRIEF DESCRIPTION OF THE SEVERAL VIEWS OF THE DRAWINGS

FIG. 1A is schematic block diagram depicting an exemplary computing environment for a query optimizer program, in accordance with an aspect of the present disclosure.

FIG. 1B is as schematic block diagram depicting components of a query optimizer program, in accordance with an aspect of the present disclosure.

FIG. 1C is a schematic block diagram of an application within the distributed data processing environment, in accordance with an embodiment of the present disclosure.

FIG. 2 is a flowchart depicting operational steps of a method for a query optimizer program, in accordance with an embodiment of the present disclosure.

FIG. 3 is a schematic block diagram depicting an exemplary User Interface (UI), according to an embodiment of the present disclosure.

FIG. 4 is a block diagram of internal and external components of computers and servers depicted in FIG. 1, according an embodiment of the present disclosure.

### DETAILED DESCRIPTION

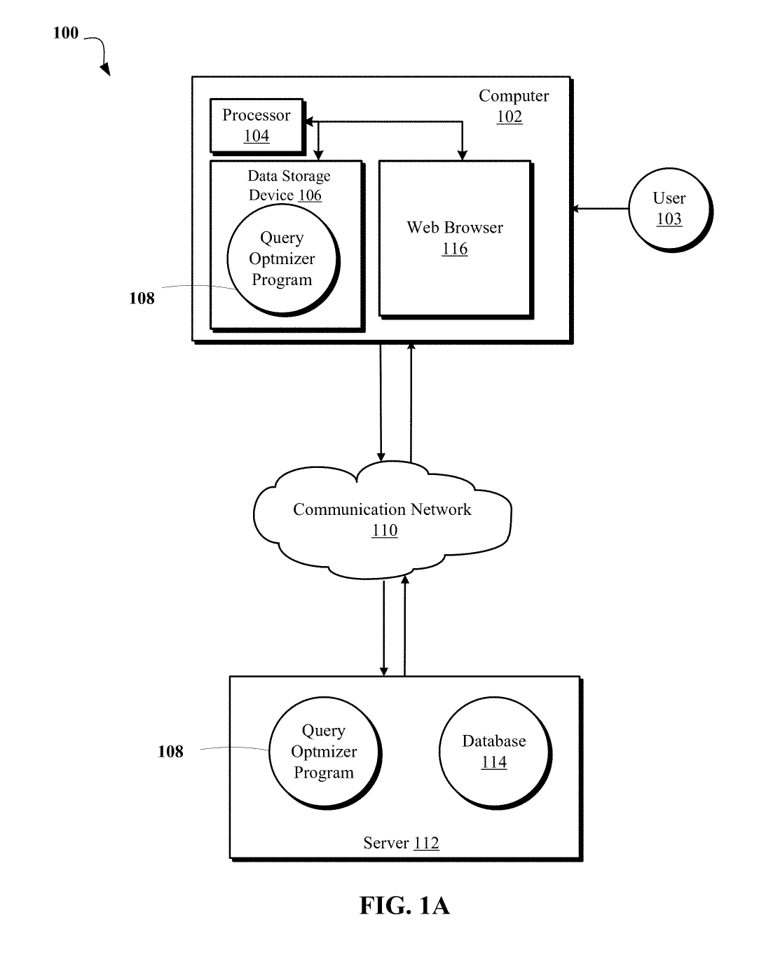

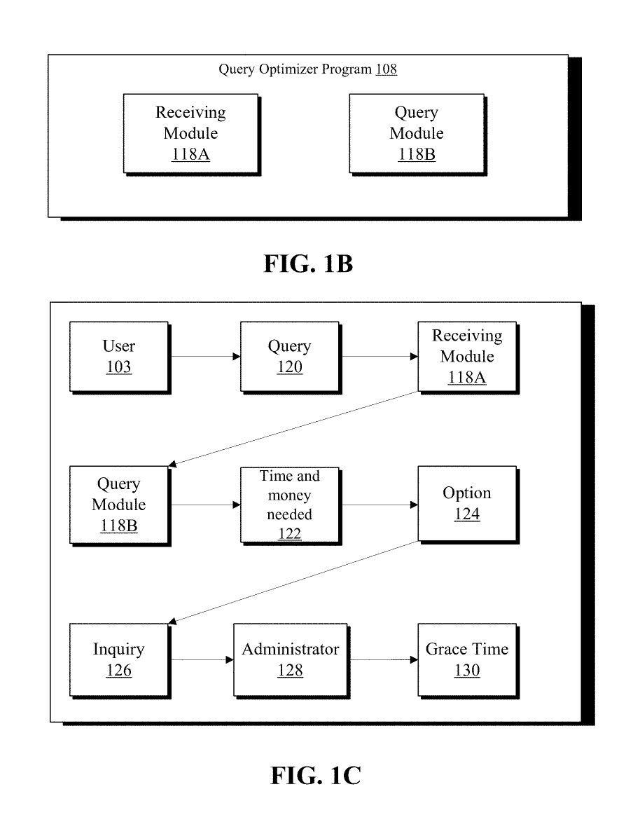

Referring to FIG. 1A, a computing environment 100 for managing the display of application forms within a web-based application is depicted. In various embodiments of the present disclosure, the computing environment 100 may include a computer 102 and server 112 connected over communication network 110.

The computer 102 may include a processor 104 and a data storage device 106 that is enabled to run a query optimizer program 108 and a web browser 116 that may display an application form or a user interface for the user to work a query optimizer program 108. Non-limiting examples of a web browser may include: Firefox®, Explorer®, or any other web browser. All brand names and/or trademarks used herein are the property of their respective owners.

The computing environment 100 may also include a server 112 with a database 114. The server 112 may be enabled to run a program such as a query optimizer program 108. A communication network 110 may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Communication network 110 may also include a number of different types of networks, such as, for example, an intranet, a local area network (LAN), or a wide area network (WAN).

It should be appreciated that FIG. 1A provides only an illustration of one implementation and does not imply any limitations with regard to the environments in which different embodiments may be implemented. Many modifications to the depicted environments may be made based on design and implementation requirements.

The computer 102 may communicate with the server 112 via the communication network 110. The communication network 110 may include connections, such as wire, wireless communication links, or fiber optic cables.

The computer 102 and the server 112 may be, for example, a mobile device, a telephone, a personal digital assistant, a netbook, a laptop computer, a tablet computer, a desktop computer, or any type of computing device capable of running a program and accessing a network. A program, such as a query optimizer program 108 may run on the computer 102 or on the server 112. It should be appreciated that query optimizer program 108 has the same component and operation methods regardless of whether it is run on the server 112 or computer 102. Therefore query optimizer program 108 applies to both query optimizer program 108 run on a computer 102 and query optimizer program 108 run on the server 112 are interchangeably used throughout this disclosure. In another embodiment, a user such as user 103 may, using computer 102, communicate with server 112 via communication network.

FIG. 1B, illustrates different modules of query optimizer program 108. In an embodiment, query optimizer program 108 may include two modules of receiving module 118A and query module 118B. Receiving module 118A may receive queries to perform from a user. Query module 118B may communicate with different networks or databases in order to perform those queries received by the receiving module 118A. Query module may also, in response to those queries timing out, calculate the time and/or cost of the queries to be completed and present and option to the user. Furthermore, query module 118B may also complete the queries based on user's input.

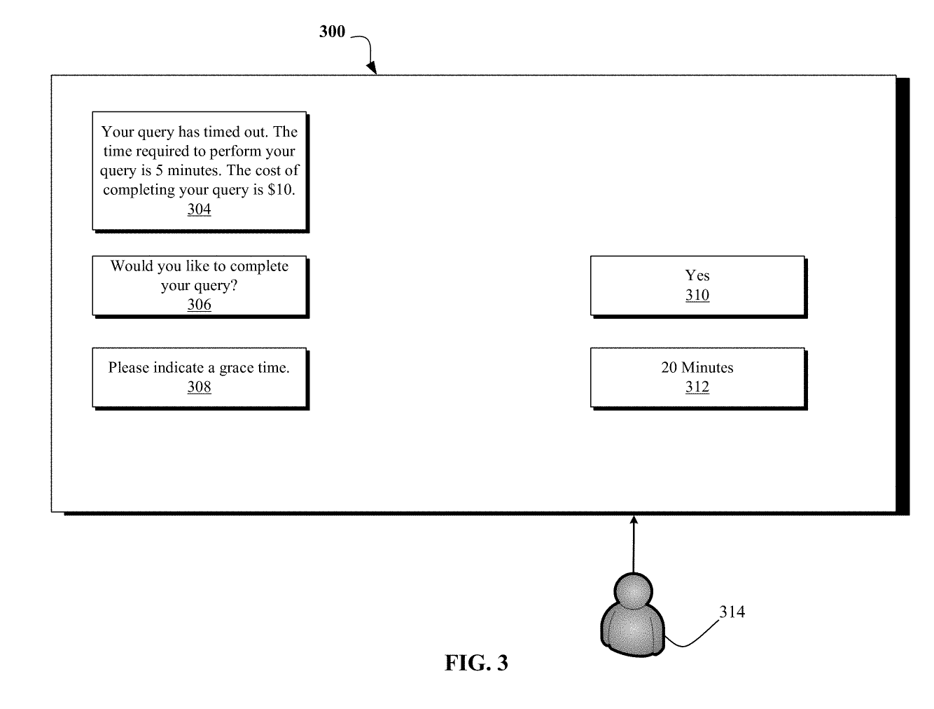

FIG. 1C is a schematic block diagram of the execution of query optimizer program 108, within the distributed data processing environment 100, in accordance with an embodiment of the present disclosure. In conjunction with FIGS. 1A-C, 2, and 3, and 4 in this embodiment, query 120 is received by the receiving module 118A from the user 103. Receiving module 118A, in this embodiment, receives the query 120 from the user 103 through the computer 102. Receiving module 118A communicates the received query 120 to the query module 118B for further processing. Query module 118B performs the query 120 and determines whether it is timed out. If it is timed out, query module 118B determines an amount of time and money needed 122 which represents the time and money needed to complete the query 120. Then the query module 118B presents the time and money needed 122 to the user 103. An example of this communication is message 304 presented in FIG. 3. Query module 118B also presents the user 103 with an option 124 language which inquires the user whether the user is willing to finish the query 120 in light of time and money needed 122. An example of the option 124 language in option 306 which is presented in FIG. 3. If the user's answer to this option is positive, query module 118B presents administrator 128 with inquiry 126. The inquiry 126, in short, asks administrator 128 for a grace time, that is, an amount of time or an amount of grace time. An example of the language of inquiry 126 is message 308 which is presented in FIG. 3. The administrator 128 may provide grace time 130. Grace time 130 represents the time, or in other words, an amount of time, that administrator 128 is willing to spend on the query 120 in order for the query 120 to be performed fully. Query module 118B, then performs query 120 within the time allotted by grace time 130.

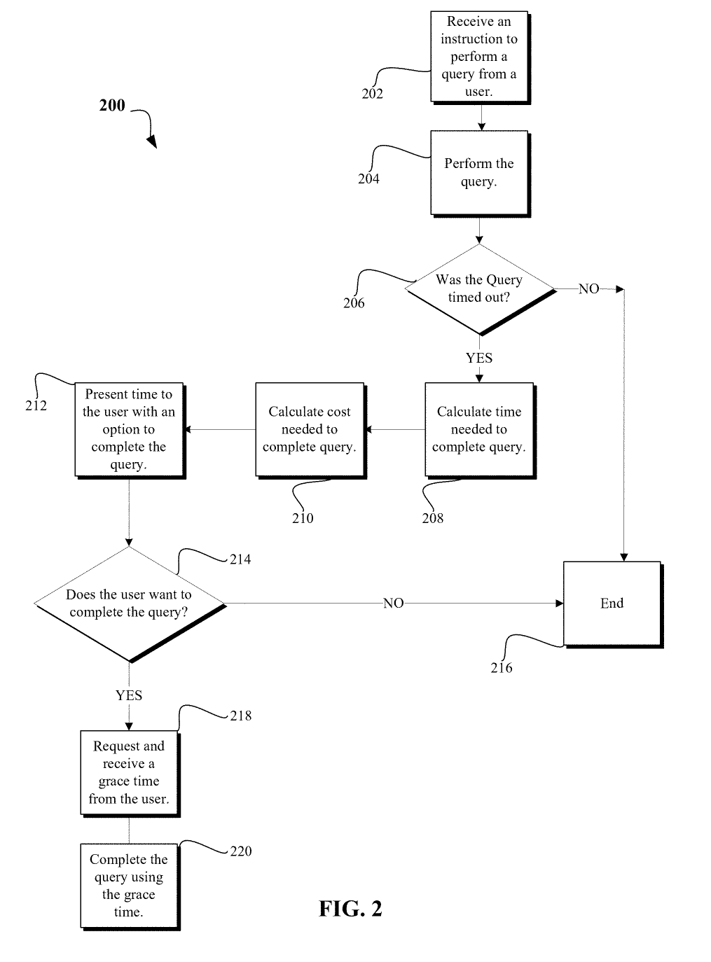

FIG. 2 is a flowchart depicting operational steps of a method for a query optimizer program 108, in accordance with an embodiment of the present invention. In this embodiment, a query is timed out and then completed based on new grace time parameters. In reference to FIGS. 1, 1B, 2, and 3, steps of method 200 may be implemented using one or more modules of a computer program, for example, query optimizer program 108, and executed by a processor of a computer, such as computer 102. It should be appreciated that FIG. 2 does not imply any limitations with regard to the environments or embodiments which may be implemented. Many modifications to the depicted environment or embodiment shown in FIG. 2 may be made.

Receiving module 118A may receive an instruction (or a set of instructions) to perform a query or a set of queries, at step 202. In general, a query is a question, command, or other instructions which often requires a communication with a database. Query instructions may be divided into different categories; for example a select query is simply a data retrieval query;

an action query can ask for additional operatic the data, such as insertion, updating, or deletion. In an embodiment, a query instruction will instruct to search or other operations by using commands such as “find,” “delete,” “print,” “sum,” and so forth. Languages used to interact with databases are called query languages, of which the Structured a guage (SQL) is the well-known standard. SQL is a special-purpose programming language designed for managing data held in a relational database management system (RDBMS), or for stream processing in a relational data stream management system (RDSMS). The sentence like structure of a SQL query resembles natural language except that its syntax is limited and fixed. Instead of using a SQL statement, it is possible to represent queries in tabular form. The technique, referred to as query-by-example (or QBE), displays an empty tabular form and expects the searcher to enter the search specifications into appropriate columns. The program then constructs a SQL-type query from the table and executes it.

Receiving module 118A may receive the query instruction(s) from a user or a computer implemented system. Non-limiting examples of an input source may be spoken words, typed words, or inputting instruction(s) electronically from a computer implemented source such as an electronic device (e.g. cell phones or tablets). In the present embodiment, user 314 using a SQL language, inputs a query instruction. The query instruction is to search company's database for income in year 2013-present using a computer.

Receiving module 118A, may perform the query instructions, at step 204. In the present embodiment query instruction is performed by communicating with a database such as database 114 using a communication network such as communication network 110 and searching for the income within the user-specified time span of 2013-present.

At 206, receiving module 118A, may determine whether the query instruction is fully performed and completed or timed out. Defining a timeout of a query allows to cancel its execution once a certain amount of time has passed since it was started. This helps protect the database by preventing this or other queries from being stalled. Simply explained, a query is timed out when its performance has taken more time than a pre-determined threshold. In an embodiment this threshold may be a time or cost threshold. If the query performance is not timed out, then method 200 may come to an end (as depicted at step 216) and present the query result to the user.

In an embodiment, receiving module 118A may determine whether a timeout has occurred using a time out profile. A timeout profile represents a server-side activity. For instance, the GRID timeout profile, may be used by the DefaultJsonDataService in the queries that are done to retrieve the records that will be shown in the grid. This embodiment utilizes a querytimeoutuntil class. A QueryTimeOutUtil class provides setQueryTimeOut methods that defines the timeout of SQL statements. In that embodiment, the first argument of the setQueryTimeOut method is the object whose query timeout is to be set. The second argument is a string that represents a timeout profile. In the present embodiment, receiving module 118A determines that a timeout has occurred because in the present embodiment the query performance takes longer than the threshold for timeout (which is 15 seconds).

If, however, the query is timed out (as depicted at step 208), query module 118B may determine the time needed to complete the query. In an embodiment, query module 118B may determine the time needed to complete the query performance by performing complex calculations based on a host of information. In an embodiment these calculations may be divided into four categories:

1. Receive and verify the syntax of the SQL statement;

2. Analyze the environment and optimize the method of satisfying the SQL statement;

3. Create machine-readable instructions to execute the optimized SQL; and

4. Execute the instructions or store them for future execution.

In accordance to the present disclosure, while query processing the above Cost, server will relate to time based on its learning of cost and time ratio of previous queries that are run in the system and thereby will be able to know the approximate time remaining when timeout occurs. This may also be done using information about past similar queries and the current network traffic.

In yet another embodiment, query module 118B may determine the time needed to complete the query using query graph. A query graph is a database that uses graph structures for queries with nodes, edges and properties to represent and store data. A query graph may include multiple nodes and each node may represent a different aspect of the operation of performance of the query. In another embodiment, a query graph may utilize tables to achieve the same goal. Query module 118B may use the query graph to determine how much time is needed to complete the query by identifying the unfished nodes. In the present embodiment, query module 118B determines that the time to complete the query is 5 minutes.

At step 210, query module 118B may calculate the cost needed to complete the query. Query module 118B may use the same above-mentioned methods as calculating the time in order to calculate the cost associated with completing the query. In the present embodiment, query module 118B determines that the cost associates with completing the query is 10 dollars.

At step 212 and step 214, query module 118B may present the user with the determined time and/or cost of completing the query and also present the user with an option to complete the query.

Referring to FIG. 3, in one example of the present embodiment, query module 118B presents user 314 with message 304 which explains the cost/time of completing the query. An option 306 is also presented which inquires the user 314 whether the user 314 is willing to spend the time/cost in order to complete the query. The 314 responds yes 310.

In an embodiment, if user's respond to the option to complete the query is negative, query module 118B may terminate the program (step 216). However, if the respond to the option to complete the query is positive, at step 218, query module 118B may, in one embodiment, request and receive a grace time from the user. Grace time is time allotted by the user to perform the query in response to the user accepting the option to complete the query. Simply put, grace time, in one embodiment, may be the extra time that the user is willing to spend in order to complete the query. This, in one embodiment, is due to the fact that factors which query module 118B has used in order to determine the time/cost of completing the query is dynamic and ever changing. Therefore, even though user has already been advised on how long it will take to complete the query, the actual completion of the query may, in some embodiments, may take longer than expected. In an embodiment, this is due to an increase in network traffic. User's grace time may ensure that completion of the query is not done without any constraints.

In another embodiment, an administrator may view the results and assign grace time based on the status of the user attempting to complete the query. For example, in that embodiment, administrator may receive 4 or 5 options to complete different queries from different users and decided, based on the status of the users or the importance of the query, how much grace time to assign to each completion. In that embodiment, a higher status user or more important query will inevitably receive a higher grace time. In the present embodiment, query module 118B receives grace time 312 from user 314. Grace time 312 is 20 minutes grace time.

At 220, query module 118B may complete the query within the allotted grace time. In the present embodiment, query module 118B perform the query instructions within the grace time 312 and displays the query results to user 314.

Referring now to FIG. 3, an exemplary User Interface (UI), according to an embodiment of the present disclosure is illustrated. Environment 300, in the present embodiment, represents a UI for query optimizer program 108. In the present embodiment, and as explained thoroughly above, user 314 receives the message 304 explaining that a query is timed out and needs 5 minutes and $10 to complete. User 314 is also given option 306 inquiring whether user 314 is willing to spend the time and money in order to complete the query. User 314 responds yes (by inputting respond 310), and receives message 308 asking user 314 to indicate a grace time.

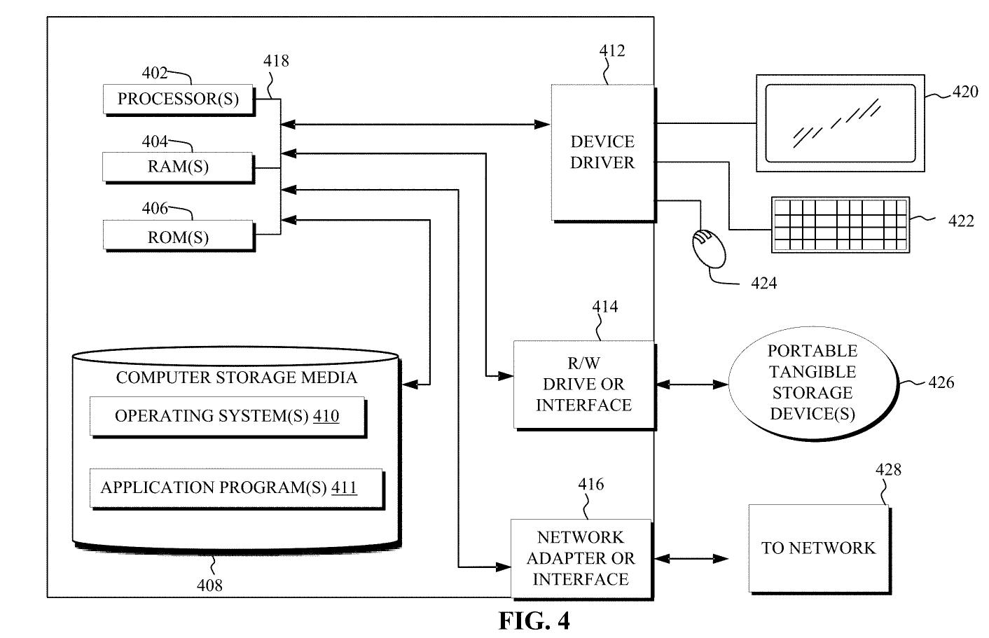

Referring now to FIG. 4 components of a generic computer system and a server such as server 112, computer 102, of computing environment 100 of FIG. 1, is illustrated in accordance with an embodiment of the present disclosure.

Server 112 may include one or more processors 402, one or more computer-readable RAMs 404, one or more computer-readable ROMs 406, one or more computer readable storage media 408, device drivers 412, read/write drive or interface 414, network adapter or interface 416, all interconnected over a communications fabric 418. Communications fabric 418 may be implemented with any architecture designed for passing data and/or control information between processors (such as microprocessors, communications and network processors, etc.), system memory, peripheral devices, and any other hardware components within a system.

One or more operating systems 410, and one or more application programs 411, are stored on one or more of the computer readable storage media 408 for execution by one or more of the processors 402 via one or more of the respective RAMs 404 (which typically include cache memory). In the illustrated embodiment, each of the computer readable storage media 408 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Server 112 and computer 102 may also include an R/W drive or interface 414 to read from and write to one or more portable computer readable storage media 426. Application programs 411 on server 112 and computer 102 may be stored on one or more of the portable computer readable storage media 426, read via the respective R/W drive or interface 414 and loaded into the respective computer readable storage media 408.

Server 112 may also include a network adapter or interface 416, such as a TCP/IP adapter card or wireless communication adapter (such as a 4G wireless communication adapter using OFDMA technology). Application programs 411 on server 112 and may be downloaded to the computing device from an external computer or external storage device via a network (for example, the Internet, a local area network or other wide area network or wireless network generally network 428) and network adapter or interface 416. From the network adapter or interface 416, the programs may be loaded onto computer readable storage media 408. The network may comprise copper wires, optical fibers, wireless transmission, routers, firewalls, switches, gateway computers and/or edge servers.

Server 112 and computer 102 may also include a display screen 420, a keyboard or keypad 422, and a computer mouse or touchpad 424. Device drivers 412 interface to display screen 420 for imaging, to keyboard or keypad 422, to computer mouse or touchpad 424, and/or to display screen 420 for pressure sensing of alphanumeric character entry and user selections. The device drivers 412, R/W drive or interface 414 and network adapter or interface 416 may comprise hardware and software (stored on computer readable storage media 408 and/or ROM 406).

While the present disclosure is particularly shown and described with respect to preferred embodiments thereof, it will be understood by those skilled in the art that changes in forms and details may be made without departing from the spirit and scope of the present application. It is therefore intended that the present disclosure not be limited to the exact forms and details described and illustrated herein, but falls within the scope of the appended claims.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Based on the foregoing, a computer system, method, and computer program product have been disclosed. However, numerous modifications and substitutions can be made without deviating from the scope of the present disclosure. Therefore, the present disclosure has been disclosed by way of example and not limitation.

1. A method for generating feedback for query execution, comprising:
receiving a query instruction, using a computer, to perform a query from a user, the query including a request for information from a database communicating with the computer;
performing the query instruction by accessing the database using a network;
calculating an amount of time needed to complete the query instruction, using a query graph model and the network traffic, in response to the query instruction performance timing out;
calculating a cost of the performing the query instructions using a query instruction graph model, in response to the query instruction performance timing out; and
presenting the cost of query and the time needed to perform the query instruction to the user.

2. The method of claim 1, further comprising:
presenting the user with an option to complete the query;
receiving a grace time from the user, the grace time being a time allotted by the user to perform the query in response to the user accepting the option to complete the query; and
performing the query based on the grace time.

3. The method of claim 2, wherein the grace time is provided by an administrator for multiple users based on a user's status.

4. The method of claim 2, wherein the grace time is provided by an administrator for multiple users based on a query's status.

5. The method of claim 2, further comprising:
receiving a second query instruction from the user;
performing the second query instruction;
presenting the user with a second option to complete the second query in response to the query instruction performance timing out;
receiving a second grace time from the user, the grace time being a time allotted by the user to perform the second query in response to the user accepting the option to complete the query in response to the query instruction performance timing out; and
performing the second query based on the grace time in response to the query instruction performance timing out.

6. The method of claim 1, wherein calculating the time needed to complete the query instruction is calculated based on past query instruction performances.

7. The method of claim 1, wherein calculating the time needed to complete the query instruction is calculated based on a query graph.

8. The method of claim 1, further comprising:
determining an amount of network traffic on the network in response to a timing out of the performing the query instruction.

9. A computer system for generating feedback for query execution, the computer system comprising:
one or more computer processors;
one or more computer-readable storage media;
program instructions stored on the computer-readable storage media for execution by at least one of the one or more processors, the program instructions comprising:
instructions to receive a query instruction, using a computer, to perform a query from a user, the query including a request for information from a database communicating with the computer;
instructions to perform the query instruction by accessing the database using a network;
instructions to calculate an amount of time needed to complete the query instruction, using a query graph model and the network traffic, in response to the query instruction performance timing out;
instructions to calculate a cost of the performing the query instructions using a query instruction graph model, in response to the query instruction performance timing out; and
instructions to present the cost of query and the time needed to perform the query instruction to the user.

10. The computer system of claim 9, further comprising:
instruction to present the user with an option to complete the query;
instructions to receive a grace time from the user, the grace time being a time allotted by the user to perform the query in response to the user accepting the option to complete the query; and
instruction to perform the query based on the grace time.

11. The computer system of claim 10, wherein the grace time is provided by an administrator for multiple users based on a user's status.

12. The computer system of claim 10, wherein the grace time is provided by an administrator for multiple users based on a query's status.

13. A computer program product for generating feedback for query execution, comprising a computer-readable storage medium having program code embodied therewith, the program code executable by a processor of a computer to perform a method comprising:
receiving a query instruction, using a computer, to perform a query from a user, the query including a request for information from a database communicating with the computer;
performing the query instruction by accessing the database using a network;
calculating an amount of time needed to complete the query instruction, using a query graph model and the network traffic, in response to the query instruction performance timing out;
calculating a cost of the performing the query instructions using a query instruction graph model, in response to the query instruction performance timing out; and
presenting the cost of query and the time needed to perform the query instruction to the user.

14. The computer program product of claim 13, further comprising:
presenting the user with an option to complete the query;
receiving a grace time from the user, the grace time being a time allotted by the user to perform the query in response to the user accepting the option to complete the query; and
performing the query based on the grace time.

15. The computer program product of claim 14, wherein the grace time is provided by an administrator for multiple users based on a user's status.

16. The computer program product of claim 14, wherein the grace time is provided by an administrator for multiple users based on a query's status.

17. The computer program product of claim 14, further comprising:
receiving a second query instruction from the user;
performing the second query instruction;
presenting the user with a second option to complete the second query in response to the query instruction performance timing out;
receiving a second grace time from the user, the grace time being a time allotted by the user to perform the second query in response to the user accepting the option to complete the query in response to the query instruction performance timing out; and
performing the second query based on the grace time in response to the query instruction performance timing out.

18. The computer program product of claim 13, wherein calculating the time needed to complete the query instruction is calculated based on past query instruction performances.

19. The computer program product of claim 13, wherein calculating the time needed to complete the query instruction is calculated based on a query graph.

20. The computer program product of claim 13, further comprising:
determining an amount of network traffic on the network in response to a timing out of the performing the query instruction.
